(19) United States
(12) Patent Application Publication
(10) Pub. No.: US 2020/0028847 A1
(43) Pub. Date: Jan. 23, 2020

(54) AUTHENTICATION METHOD AND AUTHENTICATION DEVICE

(71) Applicant: FUJITSU LIMITED, Kawasaki-shi (JP)

(72) Inventor: Hiroyuki Mizuno, Kawasaki (JP)

(73) Assignee: FUJITSU LIMITED, Kawasaki-shi (JP)

(21) Appl. No.: 16/510,350

(22) Filed: Jul. 12, 2019

(30) Foreign Application Priority Data
Jul. 17, 2018 (JP) 2018-134564

(51) Int. Cl. H04L 29/06

(52) U.S. Cl. CPC H04L 63/0876; H04L 63/0861

(57) ABSTRACT

A computer-implemented authentication method includes, when receiving first identification information of a first terminal and first feature information from the first terminal, by referring to relational information indicating relation between identification information of each terminal and identification information of each user, identifying one or more pieces of feature information associated with the first identification information, and performing a first authentication process based on a result of comparison between the identified one or more pieces of feature information and the received first feature information.

### CROSS-REFERENCE TO RELATED APPLICATION

This application is based upon and claims the benefit of priority of the prior Japanese Patent Application No. 2018-134564, filed on Jul. 17, 2018, the entire contents of which are incorporated herein by reference.

### FIELD

The embodiments discussed herein are related to an authentication technology.

### BACKGROUND

Various kinds of biometric authentication based on veins, fingerprints, handprints, faces, voiceprints, irises, and the like are used as an example of personal authentication. As one of authentication systems of such biometric authentication, “1:1 authentication” and “1:N authentication” are cited. For example, the 1:1 authentication refers to a system that receives input of identification information such as an identification (ID) and biological information from a user, and compares the biological information whose input is received with biological information associated with the ID. In addition, the 1:N authentication refers to a system that compares biological information whose input is received with N registered pieces of biological information.

Of the 1:1 authentication and the 1:N authentication, the 1:1 authentication involves the trouble of receiving the input of the ID or the like together with the biological information of the user, whereas the 1:N authentication does not involve such trouble. Therefore, the 1:N authentication has a more advantageous aspect in terms of convenience than the 1:1 authentication.

Related technologies are disclosed in Japanese Laid-open Patent Publication No. 2011-198170 and Japanese Laid-open Patent Publication No. 2001-350718, for example.

### SUMMARY

According to an aspect of the embodiments, a computer-implemented authentication method includes, when receiving first identification information of a first terminal and first feature information from the first terminal, by referring to relational information indicating relation between identification information of each terminal and identification information of each user, identifying one or more pieces of feature information associated with the first identification information, and performing a first authentication process based on a result of comparison between the identified one or more pieces of feature information and the received first feature information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a configuration of an authentication system according to a first embodiment;

FIG. 2 is a diagram illustrating an aspect of an approach to solving problems;

FIG. 3 is a block diagram illustrating an example of a functional configuration of an authentication device according to the first embodiment;

FIG. 4 is a diagram illustrating an example of a data structure of a user master;

FIG. 5 is a diagram illustrating an example of a data structure of an authentication candidate list;

FIG. 6 is a flowchart illustrating a procedure of authentication processing according to the first embodiment;

FIG. 7 is a block diagram illustrating an example of a functional configuration of an authentication device according to a second embodiment;

FIG. 8 is a diagram illustrating an example of a method of generating a session ID;

FIG. 9 is a diagram illustrating an example of session information;

FIG. 10 is a diagram illustrating an example of a policy setting;

FIG. 11 is a diagram illustrating an example of correspondence relation between areas and NW segments;

FIG. 12 is a flowchart illustrating a procedure of authentication processing according to the second embodiment;

FIG. 13 is a flowchart illustrating a procedure of determination processing according to the second embodiment; and

FIG. 14 is a diagram illustrating an example of a hardware configuration of a computer that executes an authentication program according to the first and second embodiments.

### DESCRIPTION OF EMBODIMENTS

The 1:N authentication has an aspect of involving a difficulty in performing authentication processing efficiently because an amount of authentication processing is increased as the number N of registrations of biological information is increased.

Referring to the accompanying drawings, description will hereinafter be made of an authentication program, an authentication method, and an authentication device according to the present application. It is to be noted that present embodiments do not limit the disclosed technology. In addition, embodiments may be combined with each other as appropriate within a scope where processing contents are not contradicted.

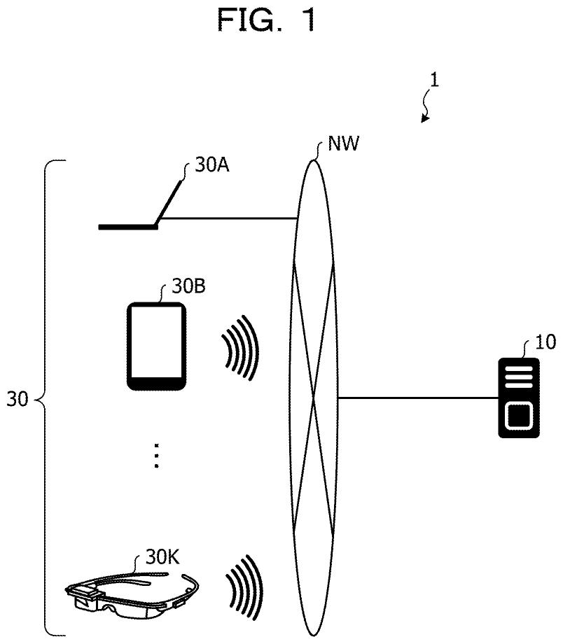

FIG. 1 is a diagram illustrating an example of a configuration of an authentication system according to a first embodiment. The authentication system 1 illustrated in FIG. 1 provides an authentication service that implements user authentication in devices 30A to 30K by 1:N biometric authentication. In the following, the devices 30A to 30K may be collectively described as “devices 30.”

As an example of use cases of such user authentication, an example is illustrated which provides a mechanism of allowing transverse use of individual services including login to the devices 30, access to applications and resources, and the like through one time of user authentication, the mechanism being so-called single sign-on (SSO). The use case cited here is a mere example, and it is needless to say that the above-described user authentication is also applicable to, for example, management of entries and exits to and from an entrance of an area such as a facility, a room, and a booth.

As illustrated in FIG. 1, the authentication system 1 includes an authentication device 10 and devices 30A to 30K. It is to be noted that while three devices 30A to 30K are illustrated as a mere example in FIG. 1, the one authentication device 10 may include an arbitrary number of devices 30.

The authentication device 10 and the devices 30 are communicably connected to each other via a given network NW. An arbitrary communication network corresponds to such a network NW, the arbitrary communication network being a local network such as a local area network (LAN), a public network such as the Internet or a mobile network irrespective of whether the network is a wired network or a wireless network. The authentication device 10 is a computer that provides the above-described authentication service.

As an embodiment, the authentication device 10 may be implemented by installing an authentication program as packaged software or online software on an arbitrary computer, the authentication program including a plurality of instructions implementing functions corresponding to the above-described authentication service. For example, the authentication device 10 may be implemented as a server device that provides the above-described authentication service on premises, or may be implemented as a cloud that provides the above-described authentication service by outsourcing.

A device 30 corresponds to a client that is provided with the above-described authentication service. The device 30 corresponds to an example of a “terminal.” The device 30 may be a notebook personal computer as illustrated as a device 30A in FIG. 1, for example, may be a smart phone as illustrated as a device 30B in FIG. 1, or may be a wearable terminal as illustrated as a device 30K in FIG. 1. Another computer than those cited here, for example, a laptop personal computer or a tablet terminal may be a client.

A biosensor not illustrated is included in or attached to the device 30. An implementation suitable for a kind of biometric authentication adopted in the authentication system 1 may be selected for the biosensor. In a case where vein authentication is performed as biometric authentication as a mere example, the biosensor may be implemented as a sensor unit including lighting applying infrared light having an appropriate wavelength for imaging a blood vessel pattern of veins present within the palm of a hand, the infrared light being, for example, near-infrared light, and a camera capable of capturing the infrared light. Under such an implementation, when the palm of a hand is placed at a given photographing position, the lighting irradiates the palm of the hand with the infrared light. The camera started so as to be interlocked with the irradiation with the infrared light photographs the infrared light reflected and returned from the inside of the palm of the hand. Such photographing provides, as a biological image, a vein image obtained by imaging the blood vessel pattern of the veins in the palm of the hand as a result of absorption of the infrared light by red blood cells in the veins.

It is to be noted that while a case is illustrated in which a vein image is photographed as an example of a biological image here, kinds of biometric authentication applicable to the authentication device 10 are not limited to this. For example, it is possible to photograph a fingerprint image in a case of performing fingerprint authentication, photograph a palm print image in a case of performing palm print authentication, or photograph an iris image as a biological image in a case of performing iris authentication.

After the biological image is thus obtained, the device 30 or the biosensor included in or attached to the device 30 generates biological information to be used for comparison at a time of biometric authentication from the biological image. The biological information is an example of feature information. Also in this case, a feature quantity suitable for a kind of biometric authentication adopted in the authentication system 1 may be generated from the biological image. In the case where vein authentication is performed as biometric authentication, for example, a blood vessel part is extracted from a vein image obtained by the biosensor and thereafter converted into fine lines, and feature quantities such as the coordinates of branch points in blood vessels, a length between the branch points, and branch angles at the branch points are extracted as the biological information. Then, the device 30 encrypts the above-described biological information according to a given encryption system, for example, an algorithm of public key encryption, and thereafter transmits the encrypted biological information to the authentication device 10. The device 30 thereby makes an authentication request to the authentication device 10.

It is to be noted that while an example of obtaining the biological image by the biosensor has been described here, the information that may be sensed by the biosensor is not limited to images. In a case where voiceprint authentication is performed, for example, features with regard to sound or language may be generated as the biological information from audio data by implementing a microphone or the like as the biosensor.

As described in the foregoing section of the background art or the like, 1:N authentication is advantageous as compared with 1:1 authentication from an aspect of convenience because 1:N authentication saves the trouble of receiving input of an ID or the like together with the biological information of the user. On the other hand, 1:N authentication has an aspect of involving difficulty in performing authentication processing efficiently because an amount of authentication processing is increased as the number N of registrations of biological information is increased.

Accordingly, the authentication device 10 according to the present embodiment has, as a difficulty in creation, a mechanism of narrowing down the biological information to be compared with biological information of an authentication request received from the device 30 from the biological information of all of N users. For example, the authentication device 10 according to the present embodiment uses, for the narrowing down for each device 30, an authentication candidate list obtained by listing, as authentication candidates, the identification information of users succeeding in authentication among users corresponding to the biological information of authentication requests received from the device 30 in the past.

Under conditions where such an authentication candidate list is generated, when the authentication device 10 according to the present embodiment receives an authentication request from the device 30, the authentication device 10 identifies m pieces of biological information corresponding to the identification information of m users having entries in the authentication candidate list corresponding to the device 30 as an issuance source of the authentication request in a user master in which the identification information and the biological information of all of N users are managed.

Then, the authentication device 10 according to the present embodiment performs 1:m biometric authentication by making comparison between the biological information of the authentication request received from the device 30 and the m pieces of biological information. When the m pieces of biological information include biological information matching the biological information of the received authentication request, for example, when authentication succeeds, the authentication device 10 according to the present embodiment transmits an authentication OK as an authentication result to the device 30 as the issuance source of the authentication request.

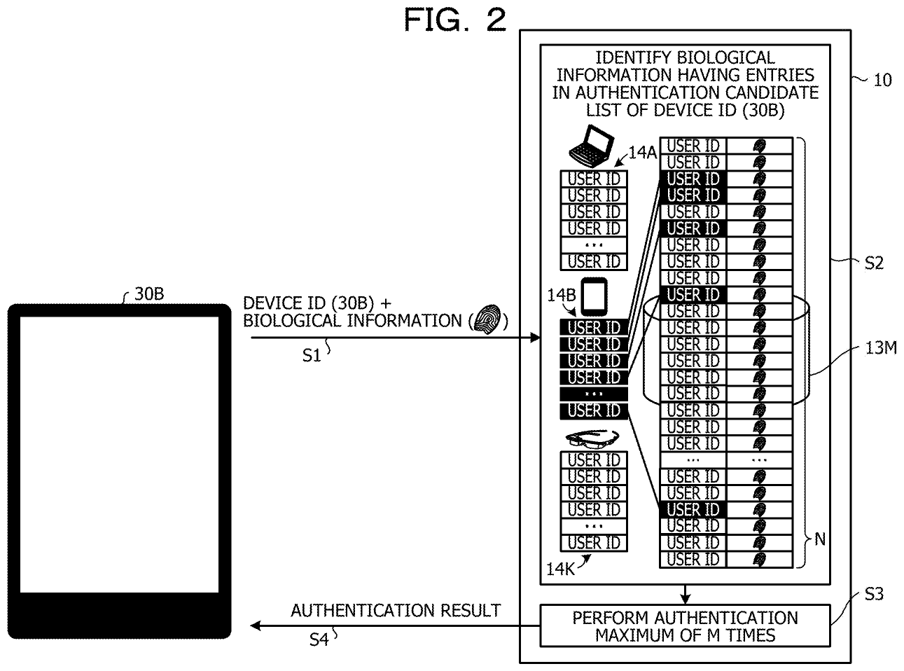

FIG. 2 is a diagram illustrating an aspect of an approach to solving the problems. FIG. 2 illustrates user IDs as an example of the identification information of users and illustrates icons obtained by converting fingerprint images into a schematic form as an example of the biological information of the users. These are in the schematic form merely for the convenience of description. A kind of characters used as the user IDs and the number of digits of the IDs may be arbitrary. In addition, actual biological information is not precluded from being information other than the biological image.

As illustrated in FIG. 2, the authentication device 10 stores, as well as a user master 13M managing the user IDs and the biological information of all of N users, authentication candidate lists 14A to 14K obtained by listing, for the respective devices 30, the user IDs of users succeeding in authentication among users corresponding to the biological information of authentication requests received from the devices 30 in the past. The authentication candidate lists 14A to 14K may hereinafter be described collectively as “authentication candidate lists 14.”

Under the management of the user master 13M and the authentication candidate lists 14, the authentication device 10 receives an authentication request from the device 30B (step S1). The authentication request includes, as an example, the identification information of the device 30 as an issuance source of the authentication request, the identification information being, for example, a device ID “30B,” and biological information generated from a biological image obtained by the biosensor of the device 30B.

When the authentication device 10 thus receives the authentication request, the authentication device 10 uses the authentication candidate list 14B corresponding to the device ID “30B” of the device 30B as the issuance source of the authentication request among the authentication candidate lists 14A to 14K to narrow down authentication candidates. For example, the authentication device 10 identifies the m pieces of biological information corresponding to the user IDs of the m users having entries in the authentication candidate list 14B among N pieces of biological information included in the user master 13M, for example, identifies biological information associated with user IDs highlighted in FIG. 2 (step S2).

Then, the authentication device 10 performs 1:m biometric authentication by making comparison between the biological information of the authentication request received from the device 30B and the m pieces of biological information (step S3). At this time, when an upper limit of the entries of the authentication candidate list 14 is limited to M, for example, one hundred the number of times that authentication is performed at the time of the narrowing down may be limited to a maximum of M times.

Here, when the m pieces of biological information include biological information matching the biological information of the received authentication request, the authentication device 10 transmits an authentication OK as an authentication result to the device 30B as the issuance source of the authentication request (step S4).

Incidentally, when the m pieces of biological information do not include biological information matching the biological information of the received authentication request, 1:N biometric authentication is retried by making comparison between the biological information of the authentication request received from the device 30B and the N pieces of biological information registered in the user master 13M. When authentication succeeds in the retry of the 1:N authentication, the user ID of the user succeeding in the authentication may be added to the entries of the authentication candidate list 14 of the device 30 as the issuance source of the authentication request. Incidentally, when the 1:N biometric authentication is retried, the 1:N biometric authentication may be performed after excluding the m pieces of biological information corresponding to the user IDs of the m users having the entries in the authentication candidate list 14B.

As described with reference to FIG. 2, the authentication device 10 according to the present embodiment uses the authentication candidate list 14 to narrow down the biological information to be set as a target of biometric authentication. For example, when users succeed once in 1:N biometric authentication with the device 30 and thereby entries of the user IDs of the users are generated in the authentication candidate list 14, the number of pieces of biological information to be compared with the biological information of the authentication request received from the device 30 may be narrowed down from N corresponding to all of the users to m as the number of entries in the authentication candidate list 14 in a second or subsequent authentication requests. Consequently, even when the number N of registrations of biological information registered in the user master 13M is increased, the number of times that biological information is compared in biometric authentication may be reduced to the number of users having a history of using the device 30 in the past. It is thus possible to suppress an increase in an amount of authentication processing.

Hence, the authentication device 10 according to the present embodiment may perform authentication processing efficiently. For example, as a result of reducing the number of pieces of biological information to be compared at a time of biometric authentication, it is possible to shorten a time needed for authentication processing or reduce a processing load on the authentication device 10.

In addition, the authentication device 10 according to the present embodiment is useful in use cases in which one device 30 is shared by a plurality of users. There are an increasing variety of devices 30 such as smart phones, wearable terminals, thin client terminals, and zero client terminals. As the devices 30 are thus diversified, there are an increasing number of situations in which one device 30 is used as a device 30 shared by a few to a few ten people, as well as a situation in which one device 30 is used as a terminal for exclusive use by one user. In the present situation, the spread of authentication services to devices 30 for exclusive use by an individual belonging to an organization has progressed, but the spread of authentication services to shared devices 30 may not be said to have progressed as much as to the devices 30 for individuals. For example, in the case of shared devices 30, an operation is more common in which the biological information of users allowed access is registered in each individual shared device 30 in advance, and each individual shared device 30 performs biometric authentication that compares the registered biological information with the biological information of a received authentication request on a stand-alone basis. When such an operation is performed, convenience is impaired because of occurrence of the trouble of registering the biological information in all of the shared devices 30 used by the users in advance. In order to deal with the present situation, the authentication device 10 according to the present embodiment generates an entry of the user ID of a user in the authentication candidate list 14 when the user once succeeds in 1:N biometric authentication with a shared device 30. Thus, the biological information does not need to be registered in all of the shared devices 30 used by the users in advance, so that convenience may be improved.

Further, the authentication device 10 according to the present embodiment adds on the authentication candidate list 14 for each device 30 in addition to the user master 13M. However, it suffices only to retain user IDs in the authentication candidate list 14, and biological information does not need to be retained in the authentication candidate list 14. It is therefore possible to minimize a memory capacity used for implementing 1:m biometric authentication.

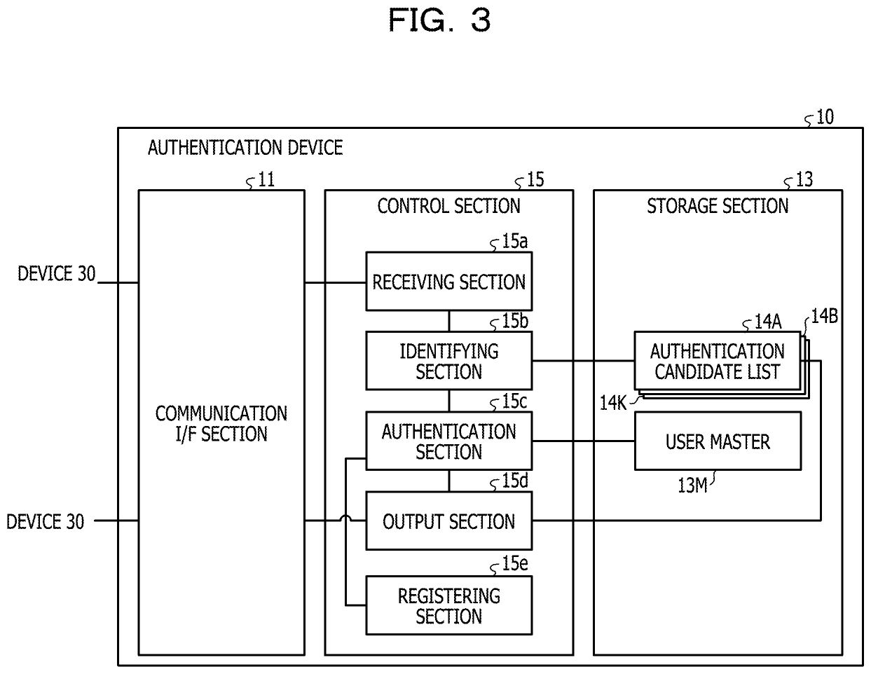

FIG. 3 is a block diagram illustrating an example of a functional configuration of the authentication device 10 according to the first embodiment. As illustrated in FIG. 3, the authentication device 10 includes a communication interface (I/F) section 11, a storage section 13, and a control section 15. While FIG. 3 illustrates solid lines representing data sending and receiving relations, FIG. 3 merely illustrates a minimum of parts for the convenience of description. For example, data input and output related to each processing section are not limited to the example illustrated in FIG. 3, and the following data input and output other than those illustrated in FIG. 3 may be performed, for example, data input and output between a processing section and a processing section, between a processing section and data, and between a processing section and an external device.

The communication I/F section 11 is a functional section corresponding to an interface that performs communication control with other devices, for example, the devices 30.

As an embodiment, a network interface card such as a LAN card corresponds to the communication I/F section 11. The communication I/F section 11, for example, receives an authentication request from a device 30 and outputs an authentication result, for example, an authentication OK or an authentication NG, in response to the authentication request to the device 30.

The storage section 13 is a functional section that stores data used for various programs including an operating system (OS) executed in the control section 15 as well as application programs including the above-described authentication program, and the like.

As an embodiment, the storage section 13 may be implemented as an auxiliary storage device in the authentication device 10. A hard disk drive (HDD), an optical disk, a solid state drive (SSD), or the like may be employed as the storage section 13. The storage section 13 may not need to be implemented as an auxiliary storage device, and the storage section 13 may also be implemented as a main storage device in the authentication device 10. In this case, various kinds of semiconductor memory elements, for example, a random access memory (RAM) and a flash memory may be employed as the storage section 13.

The storage section 13 stores the user master 13M and the authentication candidate lists 14A to 14K as an example of data used by a program executed in the control section 15. In addition to these pieces of data, the storage section 13 may store other electronic data, for example, the access rights of users.

The user master 13M is master data on users.

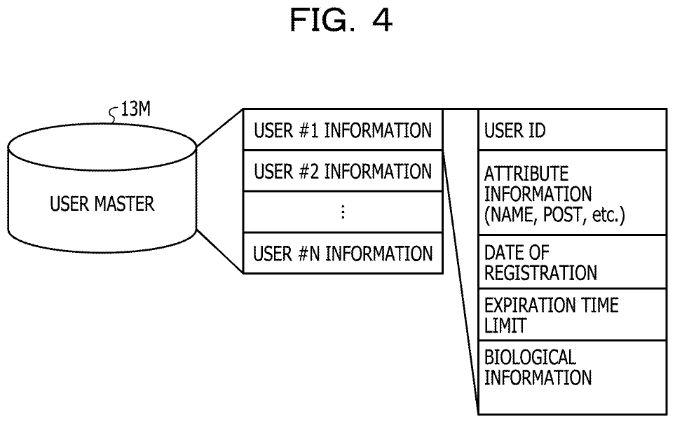

As an embodiment, data obtained by associating user IDs and biological information with each other may be adopted as the user master 13M. FIG. 4 is a diagram illustrating an example of a data structure of the user master 13M. As illustrated in FIG. 4, the user master 13M includes entries for all of the N users, for example, user #1 information to user # N information. Further picked up and illustrated in FIG. 4 are details of data included in the user #1 information among the user #1 information to the user # N information. For example, as illustrated in FIG. 4, the user #1 information includes a user ID identifying a user, attribute information of the user, for example, a name and a post, a date of registration in the user master 13M, an expiration date of the user #1 information, and the biological information of the user.

The authentication candidate lists 14A to 14K are data obtained by listing user IDs used to narrow down biological information as authentication candidates at a time of biometric authentication. The authentication candidate lists 14A to 14K are generated for the respective devices 30A to 30K.

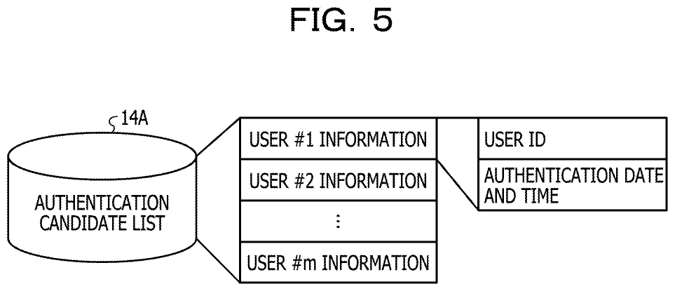

FIG. 5 is a diagram illustrating an example of a data structure of the authentication candidate list 14A. FIG. 5 illustrates the authentication candidate list 14A selected among the authentication candidate lists 14A to 14K. However, items themselves of each authentication candidate list 14 do not differ though the values of the items are different. As illustrated in FIG. 5, the authentication candidate list 14A includes entries of the m users corresponding to biological information succeeding in authentication in the biological information of authentication requests received from the device 30A, for example, includes user #1 information to user # m information. Further picked up and illustrated in FIG. 5 are details of data included in the user #1 information among the user #1 information to the user # m information. For example, as illustrated in FIG. 5, the user #1 information includes a user ID, an authentication date and time, and the like. Incidentally, a date and time that authentication succeeded last may be stored as the authentication date and time, or a date and time that authentication succeeded first may be stored as the authentication date and time.

The control section 15 is a processing section that controls the whole of the authentication device 10. As an embodiment, the control section 15 may be implemented by a hardware processor such as a central processing unit (CPU), or a micro processing unit (MPU). While a CPU or an MPU is illustrated here as an example of a processor, the control section 15 may be implemented by an arbitrary processor, for example, a graphics processing unit (GPU) or a digital signal processor (DSP) as well as a general-purpose computing on graphics processing units (GPGPU), irrespective of whether the processor is a general-purpose type or a specialized type. In addition, the control section 15 may be implemented by hard wired logic such as an application specific integrated circuit (ASIC), or a field programmable gate array (FPGA).

The control section 15 virtually implements the following processing sections by expanding the above-described authentication program including a plurality of instructions into a work area of a RAM implemented as a main storage device not illustrated. As illustrated in FIG. 3, the control section 15 includes a receiving section 15a, an identifying section 15b, an authentication section 15c, an output section 15d, and a registering section 15e.

The receiving section 15a is a processing section that receives various requests from the devices 30. As an aspect, the receiving section 15a receives an authentication request including a device ID and biological information from a device 30.

The identifying section 15b is a processing section that identifies biological information to be compared with the biological information of the authentication request received at a time of biometric authentication.

As an embodiment, when the receiving section 15a receives the authentication request, the identifying section 15b refers to the authentication candidate list 14 corresponding to the device ID included in the authentication request. At this time, when the authentication candidate list 14 does not include entries, it turns out that the device 30 as an issuance source of the authentication request is unused at present. In this case, the identifying section 15b identifies the biological information of all of the N users from the user master 13M. When the authentication candidate list 14 has entries, on the other hand, it turns out that there is an environment in which 1:m biometric authentication may be performed using the biological information of m users having entries in the authentication candidate list 14 before 1:N biometric authentication is performed. In this case, the identifying section 15b identifies the biological information corresponding to the user IDs of the m entries in the authentication candidate list 14 in the biological information of N people which biological information is included in the user master 13M.

The authentication section 15c is a processing section that performs biometric authentication. As an embodiment, the authentication section 15c calculates a degree of similarity that indexes feature correlation or shape correlation between the biological information of the authentication request received by the receiving section 15a and the biological information identified by the identifying section 15b. The authentication section 15c then determines an authentication success, for example, an authentication OK when the biological information identified by the identifying section 15b includes biological information whose degree of similarity to the biological information of the authentication request received by the receiving section 15a is substantially equal to or higher than a given threshold value. On the other hand, the authentication section 15c determines an authentication failure, for example, an authentication NG when the biological information identified by the identifying section 15b does not include biological information whose degree of similarity to the biological information of the authentication request received by the receiving section 15a is substantially equal to or higher than the given threshold value.

The output section 15d is a processing section that controls output of data to the devices 30. As an aspect, when authentication is performed by the authentication section 15c, the output section 15d outputs an authentication result in response to an authentication request to a device 30 as an issuance source of the authentication request.

The registering section 15e is a processing section that registers user IDs in the authentication candidate list 14. As an embodiment, when 1:N biometric authentication by the authentication section 15c succeeds, the registering section 15e retrieves, from the user master 13M, a user ID associated with biological information succeeding in the 1:N biometric authentication. The registering section 15e then adds the entry of the user ID retrieved from the user master 13M to the authentication candidate list 14 corresponding to a device 30 as an issuance source of an authentication request. At this time, when the entry of the user ID retrieved from the user master 13M is present in the authentication candidate list 14, the registering section 15e does not have to add the entry to the authentication candidate list 14 from an aspect of avoiding repeated registration into the authentication candidate list 14. In this case, the registering section 15e may update an authentication date and time of the entry of the user ID retrieved from the user master 13M to a latest date and time.

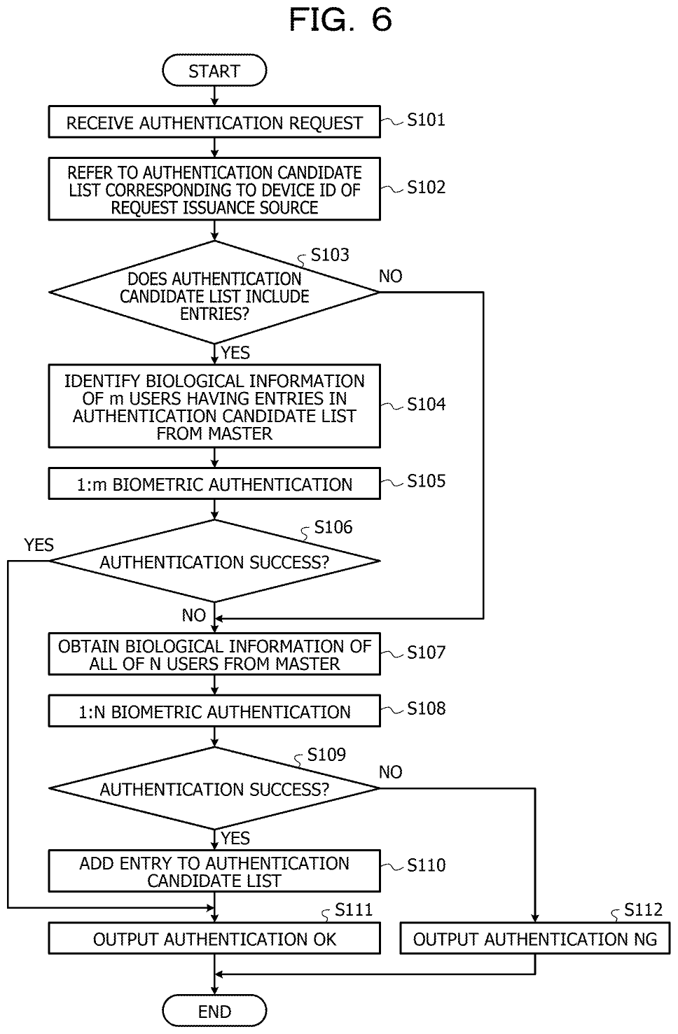

FIG. 6 is a flowchart illustrating a procedure of authentication processing according to the first embodiment. This processing is started when an authentication request is received from a device 30 as an example. As illustrated in FIG. 6, when the receiving section 15a receives the authentication request (step S101), the identifying section 15b refers to the authentication candidate list 14 corresponding to a device ID included in the authentication request received in step S101 (step S102).

At this time, when the authentication candidate list 14 includes entries (Yes in step S103), the identifying section 15b identifies biological information corresponding to the user IDs of the m entries present in the authentication candidate list 14 referred to in step S102 in the biological information of N people which biological information is included in the user master 13M (step S104). The authentication section 15c then performs 1:m biometric authentication between the biological information of the authentication request received in step S101 and the m pieces of biological information identified in step S104 (step S105).

Here, when the 1:m biometric authentication succeeds (Yes in step S106), the output section 15d outputs an authentication OK as an authentication result to the device 30 as an issuance source of the authentication request (step S111), and ends the processing.

When the 1:m biometric authentication does not succeed (No in step S106), on the other hand, it turns out that the authentication request is made by a person who has not used the device 30. In addition, when the authentication candidate list 14 does not have entries (No in step S103), it turns out that the device 30 as the issuance source of the authentication request is unused at present.

When these cases apply (No in step S103 or No in step S106), the identifying section 15b identifies the biological information of all of the N users from the user master 13M (step S107). The authentication section 15c then performs 1:N biometric authentication between the biological information of the authentication request received in step S101 and the biological information of all of the N users which biological information is identified in step S107 (step S108).

Here, when the 1:N biometric authentication succeeds (Yes in step S109), the registering section 15e retrieves, from the user master 13M, the user ID associated with the biological information succeeding in the 1:N biometric authentication, and adds the entry of the user ID to the authentication candidate list 14 corresponding to the device 30 as the issuance source of the authentication request (step S110). Then, the output section 15d outputs an authentication OK as an authentication result to the device 30 as the issuance source of the authentication request (step S111), and ends the processing.

When the 1:N biometric authentication does not succeed (No in step S109), on the other hand, it turns out that the person making the authentication request received in step S101 is a person whose biological information is not registered in the user master 13M. In this case, the output section 15d outputs an authentication NG as an authentication result to the device 30 as the issuance source of the authentication request (step S112), and ends the processing.

As described above, the authentication device 10 according to the present embodiment performs 1:m biometric authentication after narrowing down the number of pieces of biological information to be compared with the biological information of the received authentication request from all of the N users registered in the master to the m people having an actual result of authentication success with the device 30 as the issuance source of the authentication request. Consequently, even when the number N of registrations of biological information registered in the user master 13M is increased, it is possible to suppress an increase in the amount of authentication processing. Hence, the authentication device 10 according to the present embodiment may perform authentication processing efficiently.

In a second embodiment, description will be made of an authentication device 20 having a function added on thereto which suppresses a decrease in security even under circumstances where a device 30 may be moved by, for example, being carried by a user after a success in biometric authentication, as compared with the authentication device 10 according to the foregoing first embodiment.

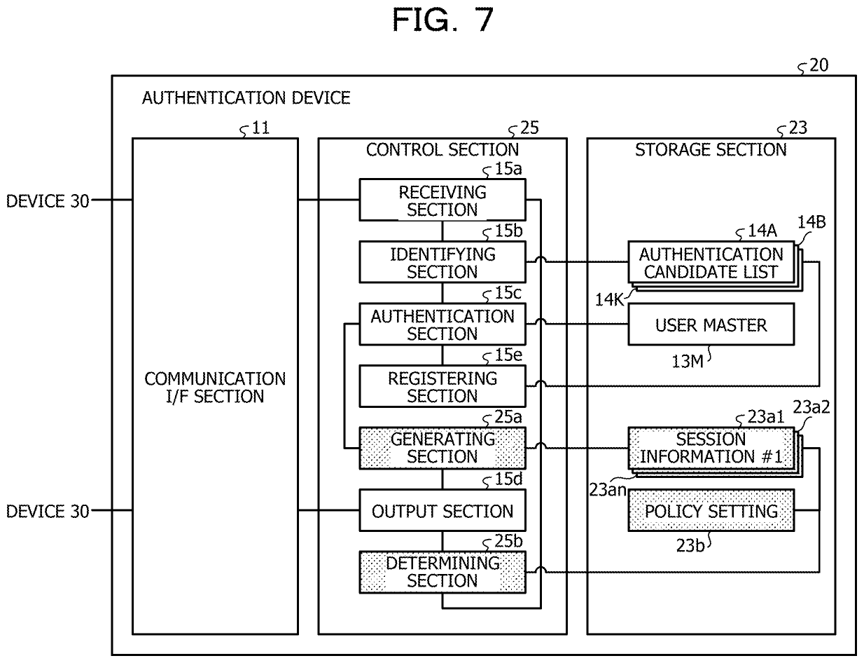

FIG. 7 is a block diagram illustrating an example of a functional configuration of the authentication device 20 according to the second embodiment. FIG. 7 illustrates, by hatching, blocks corresponding to functional sections not included in the authentication device 10 illustrated in FIG. 3 and functional sections having same labels as functional sections included in the authentication device 10 illustrated in FIG. 3 but partly having different functions.

As illustrated in FIG. 7, the authentication device 20 is different from the authentication device 10 illustrated in FIG. 3 in that the authentication device 20 stores session information #1 to # n and a policy setting 23b in a storage unit 23. Further, the authentication device 20 is different in that a control unit 25 further includes a generating section 25a and a determining section 25b. Incidentally, the session information #1 to # n and the policy setting 23b will be described later in accordance with a situation in which session information 23a1 to 23an is generated and a situation in which the policy setting 23b is referred to.

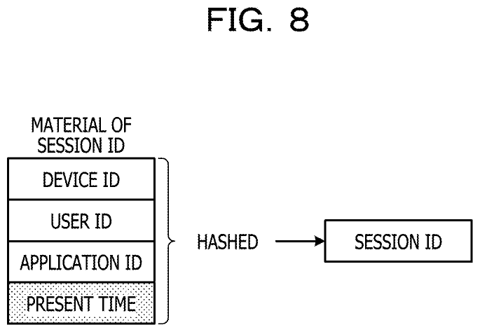

The generating section 25a is a processing section that generates session information. As an embodiment, the generating section 25a generates a session ID when an authentication result of the authentication section 15c is an authentication success, for example, when 1:m biometric authentication or 1:N biometric authentication succeeds. FIG. 8 is a diagram illustrating an example of a method of generating the session ID. As illustrated in FIG. 8, the generation of the session ID uses a device ID, a user ID, an application ID, and a present time. The “device ID” referred to here corresponds to the device ID of a device 30 succeeding in biometric authentication. In addition, the “user ID” corresponds to the user ID of a user succeeding in the biometric authentication among user IDs in the user master 13M. In addition, the “application ID” corresponds to the application ID of an application being executed in the device 30 as an issuance source of an authentication request. Further, the “present time” corresponds to a time that the biometric authentication succeeds. A hash value generated by hashing the device ID, the user ID, the application ID, and the present time is used as the “session ID.”

Here, the present time is used to generate the session ID from an aspect of suppressing forgery of the session ID by a third party. For example, the device ID, the user ID, and the application ID other than the present time are often fixed character strings difficult to change after being defined by numbering or the like. If only such fixed character strings are used to generate the session ID, a possibility of the session ID being forged is increased when the device ID, the user ID, and the application ID are leaked or estimated. Hence, even when the part of the fixed character strings is leaked or estimated, forgery of the session ID is suppressed by using the character string of time in generating the session ID, the character string changing with the passage of time.

After thus generating the session ID, the generating section 25a stores session information including the session ID in the storage unit 23.

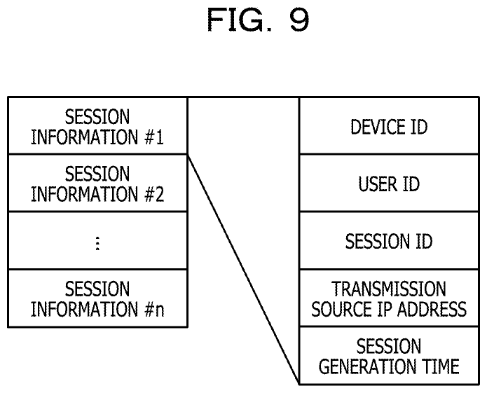

FIG. 9 is a diagram illustrating an example of the session information. FIG. 9 illustrates, as a mere example, an example in which n sessions are established between the authentication device 10 and n devices 30. In this case, as illustrated in FIG. 9, the storage unit 23 stores session information #1 to session information # n. Further picked up and illustrated in FIG. 9 are details of data included in the session information #1 among the session information #1 to the session information # n. For example, as illustrated in FIG. 9, the session information #1 includes a device ID, a user ID, an internet protocol (IP) address, a session generation time, and the like in addition to the above-described session ID. The “device ID” referred to herein corresponds to the device ID of a device 30 succeeding in biometric authentication. In addition, the “user ID” corresponds to the user ID of a user succeeding in the biometric authentication among the user IDs in the user master 13M. In addition, the “IP address” corresponds to an IP address assigned to the device 30 at a time of establishment of the session, for example, at a time of succeeding in the biometric authentication. In addition, the “session establishment date and time” corresponds to a date and time that the session is established as a result of the success in the biometric authentication. Though not illustrated, the values of the items of the session ID, the device ID, the user ID, the IP address, and the session generation time in the session information #2 to the session information # n are different but the items themselves do not differ.

The user of the device 30 having the session thus established between the device 30 and the authentication device 10 is allowed services including login to the device 30, access to applications and resources, and the like within a scope of rights granted to the account of the user as long as the valid session is continued. On the other hand, allowing the session to be continued without limitation may invite a decrease in security. Thus, a certain limitation may be imposed on the continuation of the session from an aspect of security.

For example, after the establishment of the session, conditioned on the passage of a given period, for example, a period of 10 minutes, a return from a standby mode, a start of an application, or the like, the device 30 transmits a session continuation request to the authentication device 10. At this time, the session continuation request may be transmitted to the authentication device 10, as well as the session ID, the device ID, the user ID, the application ID, the IP address, and the like are included in the session continuation request at a time of issuance of the session continuation request. Whether or not a criterion set from a viewpoint of security, a so-called policy, is met is determined using the information thus transmitted from the device 30 to the authentication device 10 at the time of the session continuation request.

The determining section 25b is a processing section that determines whether or not to approve the continuation of the session. This determining section is an example of a control section. As an embodiment, the determining section 25b operates as follows when the receiving section 15a receives the session continuation request from the device 30. The determining section 25b determines whether or not the session information #1 to the session information # n stored in the storage unit 23 include a session ID matching the session ID received in the session continuation request. At this time, when the session information #1 to the session information # n do not include the session ID matching the session ID received in the session continuation request, it turns out that the session requested to be continued by the device 30 is not a normal session. In this case, the determining section 25b discards the session by making the device 30 delete the session ID maintained by the device 30. When the session information #1 to the session information # n include the session ID matching the session ID received in the session continuation request, on the other hand, the determining section 25b obtains the policy setting 23b stored in the storage unit 23 from an aspect of determining whether or not the above-described policy is met.

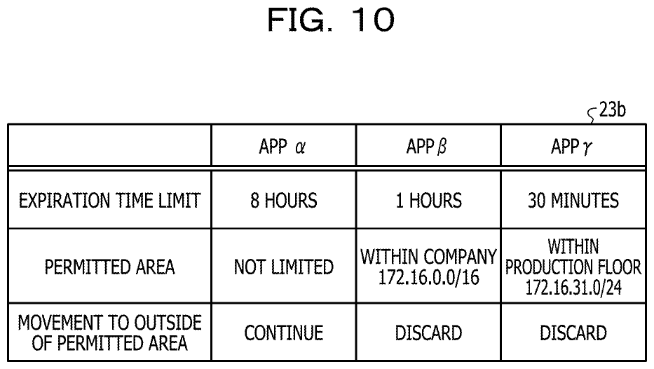

FIG. 10 is a diagram illustrating an example of the policy setting 23b. “APP” entered in FIG. 10 is an abbreviation of application. As illustrated in FIG. 10, conditions related to times and places are illustrated as an example of conditions imposed on the usage of three applications, for example, apps α to γ. In this case, the following description will be made supposing as an example that the level of security is increased in order of the app α, the app β, and the app γ. For example, an email system or the like corresponds to the app α, the email system assuming viewing also outside a company, a document managing system or the like corresponds to the app β, the document managing system managing documents to be kept secret from the outside of the company, and a production equipment managing system or the like corresponds to the app γ, the production equipment managing system assuming secrets from other departments than a production department, or so-called secrets from the outside of the department. These examples are illustrations intended to clarify the setting of different policies for the respective apps, and the setting of policies for applications other than illustrated is not precluded.

As an example of time conditions imposed on the usage of the apps α to γ, session expiration time limits are set, as illustrated in a first row of FIG. 10. For example, in a case where the app α is used on the device 30, it means that the session is valid for eight hours from a point in time that the session is established. In addition, in a case where the app β is used on the device 30, it means that the session is valid for one hour from a point in time that the session is established. Further, in a case where the app γ is used on the device 30, it means that the session is valid for 30 minutes from a point in time that the session is established. It is possible to thus set the session expiration time limits for the respective apps individually, and in addition, to automatically set an expiration time limit of a longer period as the level of security is increased.

Further, as an example of location conditions imposed on the usage of the apps α to γ, areas in which the usage of the applications is permitted, which areas will hereinafter be “permitted areas,” are set, as illustrated in a second row of FIG. 10. As illustrated in FIG. 10, the permitted areas are defined by network segments, which will hereinafter be “NW segments,” as an example. Further, in a third row of FIG. 10, a setting is defined as to whether the session is continued or discarded when a movement occurs from the permitted area to the outside of the permitted area.

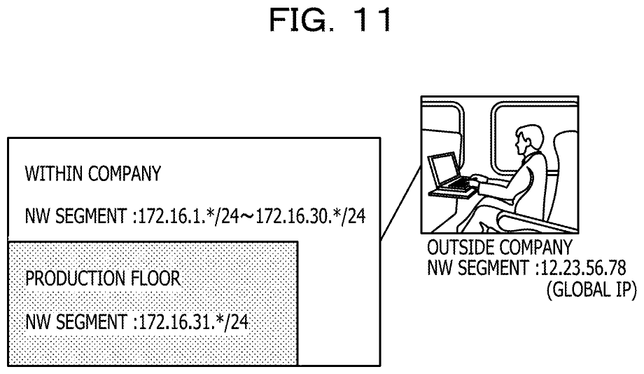

Here, FIG. 11 illustrates an example of correspondence relation between areas and NW segments. FIG. 11 is a diagram illustrating an example of correspondence relation between areas and NW segments. FIG. 11 schematically illustrates two areas of the inside of a company and a production floor corresponding to NW segments defining the permitted areas illustrated in FIG. 10. FIG. 11 indicates that the area of the production floor is included in the area within the company. Further, it is indicated that IP addresses in a range of NW segments “172.16.1.*/24 to 172.16.31.*/24” are used in the area within the company, and IP addresses in a range of “172.16.31.*/24” are used in the area of the production floor.

When the NW segments of the permitted areas are viewed under such correspondence relation, the permitted area of the app α illustrated in FIG. 10 does not have any limitation on NW segments. For example, it is indicated that the usage of the app α is permitted irrespective of whether the IP address of the device 30 is a global IP address or a private IP address. In addition, the permitted area of the app β illustrated in FIG. 10 is IP addresses in a range of an NW segment “172.16.0.0/16.” Thus, it is indicated that the usage of the app β is permitted in the area within the company, the area including the production floor. Further, the permitted area of the app γ illustrated in FIG. 10 is IP addresses in a range of an NW segment “172.16.31.0/24.” Thus, it is indicated that the usage of the app γ is permitted in the area of the production floor. It is further indicated that the session is discarded in both of a case where the device 30 is moved to the outside of the permitted area during the usage of the app β and a case where the device 30 is moved to the outside of the permitted area during the usage of the app γ.

After thus obtaining the policy setting 23b, the determining section 25b determines whether or not the IP address of the device 30 which IP address is received in the session continuation request matches an IP address within an entry of session information matching the session ID received in the session continuation request. For example, this is functionally equivalent to determination of the determining section 25b as to whether or not the IP address of the device 30 matches between the time of establishment of the session and the time of the session continuation request. Whether the device 30 is moved in a period between the time of establishment of the session and the time of the session continuation request may be determined by such determination.

When the two IP addresses do not match each other, it turns out that the device 30 is moved. In this case, the determining section 25b further determines whether or not the IP address of the device 30 which IP address is received in the session continuation request is included in the range of the NW segment of the permitted area corresponding to the application ID received in the session continuation request among the permitted areas defined in the policy setting 23b. Such determination is made because a change of the NW segment to which the device 30 belongs may not mean movement to the outside of the permitted area. For example, whether the movement of the device is a movement within the permitted area or a movement to the outside of the permitted area is determined.

Here, when the IP addresses match each other, or when the IP addresses do not match each other but the device 30 is within the permitted area, it turns out that the app is used in a location meeting the policy. In this case, the determining section 25b further determines whether or not the expiration time limit of the session corresponding to the application ID received in the session continuation request is not exceeded, the expiration time limit being among the session expiration time limits defined in the policy setting 23b, based on the session establishment time in the entry of the session information matching the session ID received in the session continuation request.

Then, when the expiration time limit of the session is not exceeded, it turns out that the usage of the app meets the policy in both aspects of the location and the time. In this case, the determining section 25b approves the continuation of the session, omits biometric authentication, and outputs an authentication OK as an authentication result to the device 30.

When the device 30 is outside the permitted area or when the expiration time limit of the session is exceeded, on the other hand, it turns out that the usage of the app violates the policy in either the location or the time. In this case, the determining section 25b denies the continuation of the session, and discards the session information stored in the storage unit 23. At this time, in the case where the device 30 is outside the permitted area, the policy is violated even when biometric authentication is performed again. The determining section 25b may therefore make the output section 15d perform control that outputs, to the device 30, an alert to the effect that the execution itself of the app is not permitted. In addition, when the expiration time limit of the session is exceeded, there is room for establishing a session again. The determining section 25b therefore requests the device 30 to make an authentication request in order to perform biometric authentication of the device 30 again.

Description will next be made of a flow of processing of the authentication device 20 according to the present embodiment. In the following, description will be made in order of authentication processing and determination processing performed by the authentication device 20.

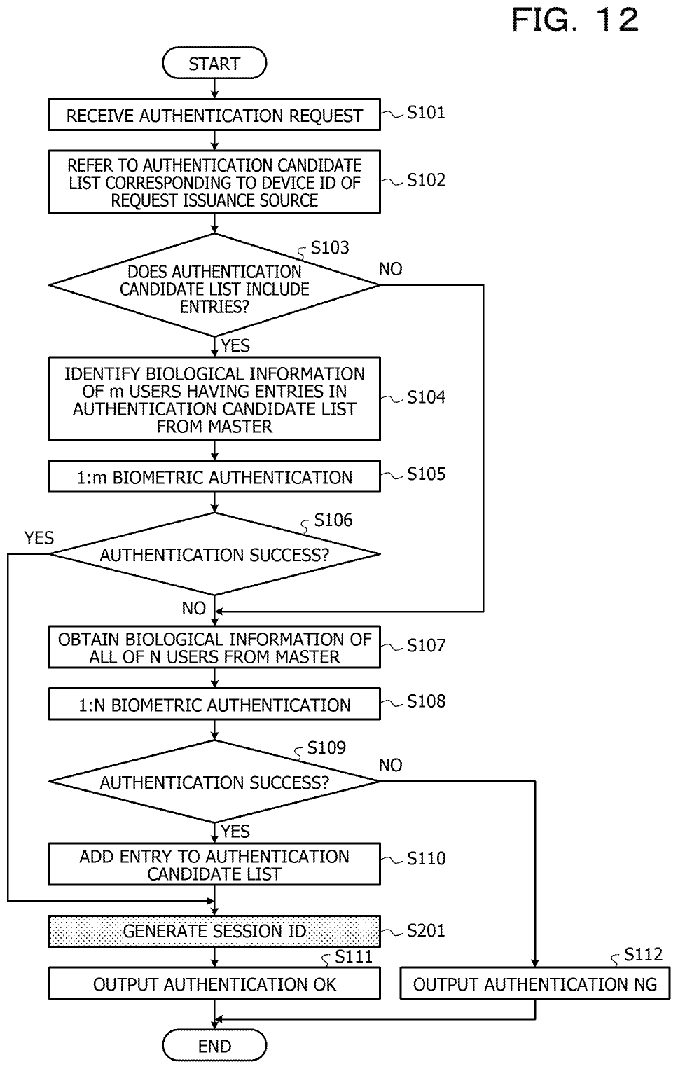

FIG. 12 is a flowchart illustrating a procedure of authentication processing according to the second embodiment. In FIG. 12, procedures in which the same processing as the authentication processing illustrated in FIG. 6 is performed are given the same step numbers, while a procedure added to the authentication processing illustrated in FIG. 6 is given a different step number, and the part of the procedure is indicated by hatching.

As with the authentication processing illustrated in FIG. 6, the authentication processing illustrated in FIG. 12 is started when an authentication request is received from a device 30 as an example. The authentication processing illustrated in FIG. 12 is different from the authentication processing illustrated in FIG. 6 in that a procedure of the following step S201 is added after a branch of Yes in step S106 or after step S110 is performed.

For example, the procedure of the following step S201 is performed when 1:m biometric authentication or 1:N biometric authentication succeeds. For example, the generating section 25a generates a session ID, based on the device ID of the device 30 succeeding in the biometric authentication, the user ID of a user succeeding in the biometric authentication among the user IDs in the user master 13M, the application ID of an application being executed on the device 30 as the issuance source of the authentication request, and a time that the biometric authentication succeeds (step S201).

The thus generated session ID is stored in the storage unit 23 as session information including an IP address assigned to the device 30 at a time of establishment of the session in addition to the above-described device ID, the above-described user ID, and the above-described time.

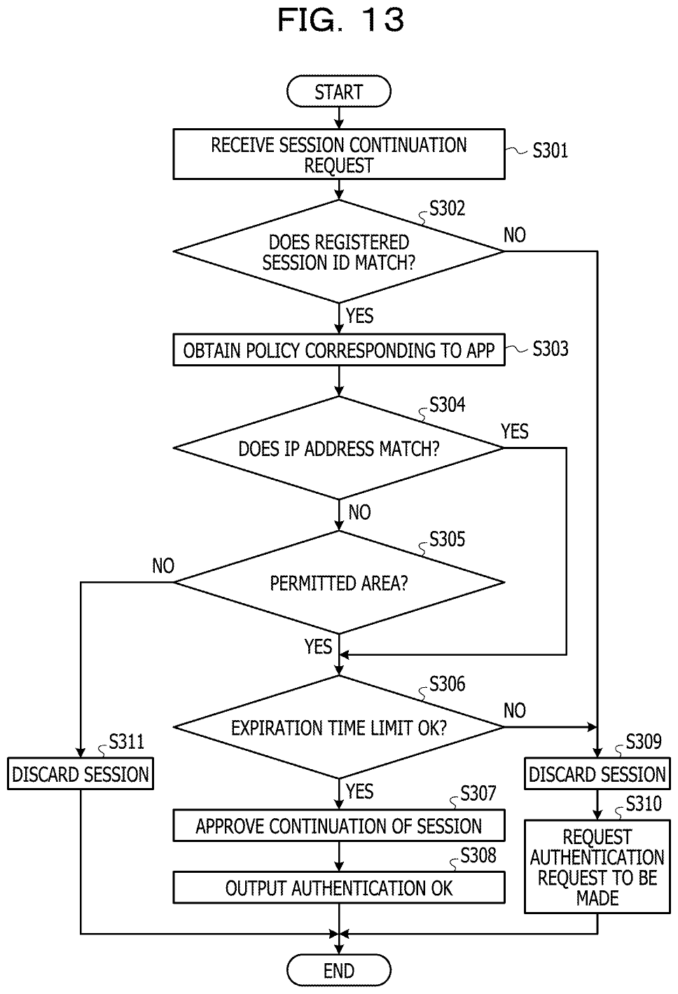

FIG. 13 is a flowchart illustrating a procedure of determination processing according to the second embodiment. This processing is performed when the receiving section 15a receives a session continuation request from a device 30, as an example.

As illustrated in FIG. 13, when a session continuation request is received from a device 30 (step S301), the determining section 25b determines whether or not the session information #1 to the session information # n stored in the storage unit 23 include a session ID matching a session ID received in step S301 (step S302).

At this time, when the session information #1 to the session information # n include a session ID matching the session ID received in step S301 (Yes in step S302), the determining section 25b obtains the policy setting 23b stored in the storage unit 23 (step S303).

Then, the determining section 25b determines whether or not an IP address of the device 30 which IP address is received in step S301 matches an IP address within the entry of session information matching the session ID received in step S301 (step S304). This step S304 indicates whether or not the device 30 is moved in a period between the time of establishment of the session and the time of the session continuation request.

When the two IP addresses do not match each other (No in step S304), it turns out that the device 30 is moved. In this case, the determining section 25b further determines whether or not the IP address of the device 30 which IP address is received in step S301 is included in the range of the NW segment of a permitted area corresponding to an application ID received in step S301 among the permitted areas defined in the policy setting 23b (step S305).

Here, when the IP addresses match each other, or when the IP addresses do not match each other but the device 30 is within the permitted area (Yes in step S304 or Yes in step S305), it turns out that the app is used in a location meeting the policy. In this case, the determining section 25b further determines whether or not the expiration time limit of the session corresponding to the application ID received in step S301 is not exceeded, the expiration time limit being among the session expiration time limits defined in the policy setting 23b, based on a session establishment time in the entry of the session information matching the session ID received in step S301 (step S306).

Then, when the expiration time limit of the session is not exceeded (Yes in step S306), it turns out that the usage of the app meets the policy in both aspects of the location and the time. In this case, the determining section 25b approves the continuation of the session (step S307), omits biometric authentication, and outputs an authentication OK as an authentication result to the device 30 (step S308). The determining section 25b then ends the processing.

In addition, when the session information #1 to the session information # n do not include the session ID matching the session ID received in step S301, or when the expiration time limit of the session is exceeded (No in step S302 or No in step S306), the continuation of the session is denied. In this case, the determining section 25b discards the session information stored in the storage unit 23 (step S309). Together with this, the output section 15d requests the device 30 to make an authentication request in order to perform biometric authentication for the device 30 again (step S310). The output section 15d then ends the processing.

In addition, when the device 30 is outside the permitted area (No in step S305), it turns out that the app is used in a location not meeting the policy. In this case, the continuation of the session is denied. In this case, the determining section 25b discards the session information stored in the storage unit 23 (step S311). The determining section 25b then ends the processing.

Incidentally, in the flowchart illustrated in FIG. 13, a case is illustrated in which it is determined that the policy is met as long as the device 30 is within the permitted area even when the IP addresses do not match each other (No in step S304 and Yes in step S305). However, when the IP addresses do not match each other, the present session may be discarded and the device 30 may be requested to make an authentication request from an aspect of establishing a session again.

As described above, as in the foregoing first embodiment, the authentication device 20 according to the present embodiment performs 1:m biometric authentication after narrowing down the number of pieces of biological information to be compared with the biological information of the received authentication request from all of the N users registered in the master to the m people having an actual result of authentication success with the device 30 as the issuance source of the authentication request. Hence, as in the foregoing first embodiment, the authentication device 20 according to the present embodiment may also perform authentication processing efficiently.

Further, the authentication device 20 according to the present embodiment establishes a session between the authentication device 20 and the device 30 and stores an IP address at a time of success in biometric authentication. When a session continuation request is received after the establishment of the session, the authentication device 20 determines whether or not to approve the continuation of the session according to whether or not the IP address matches between the time of the establishment of the session and the time of the session continuation request. Thus, the authentication device 20 according to the present embodiment continues the session when the device 30 is not moved, whereas the authentication device 20 may discard the session when the device 30 is moved. Hence, the authentication device 20 according to the present embodiment may suppress a decrease in security even under circumstances where the device 30 may be moved by, for example, being carried by the user.

In addition, the authentication device 20 according to the present embodiment may determine whether or not to approve the continuation of the session according to the policy in which permitted areas and session expiration time limits different for the respective applications executed on the device 30 are set. Thus, the authentication device 20 according to the present embodiment may approve the continuation of the session only when the usage of the application meets the policy in both aspects of the location and the time. Hence, the authentication device 20 according to the present embodiment may suppress a decrease in security when the application is used in such a manner as to violate the policy.

Embodiments related to the disclosed device have been described thus far. However, the present technology may also be carried out in various different forms other than the foregoing embodiments. Accordingly, other embodiments included in the present technology will be described in the following.

In the foregoing first embodiment and the foregoing second embodiment, description has been made of an example in which authentication candidate lists are retained for respective devices 30. However, even an authentication candidate list for a same device 30 may be further subdivided by day of the week or time period so that authentication candidate lists may be retained for different days of the week and/or different time periods.

In addition, the constituent elements of each device illustrated in the figures may not need to be physically configured as illustrated in the figures. For example, concrete forms of distribution and integration of each device are not limited to those illustrated in the figures, and the whole or a part of each device may be configured so as to be distributed and integrated functionally or physically in arbitrary units according to various kinds of loads, usage conditions, or the like. For example, the receiving section 15a, the identifying section 15b, the authentication section 15c, or the output section 15d may be connected as a device external to the authentication device 10 via a network. In addition, the receiving section 15a, the identifying section 15b, the authentication section 15c, the output section 15d, the generating section 25a, or the determining section 25b may be connected as a device external to the authentication device 20 via a network. In addition, the receiving section 15a, the identifying section 15b, the authentication section 15c, or the output section 15d may each be possessed by a different device, may be network-connected, and may cooperate to thereby implement functions of the authentication device 10 described above. In addition, the receiving section 15a, the identifying section 15b, the authentication section 15c, the output section 15d, the generating section 25a, or the determining section 25b may each be possessed by a different device, may be network-connected, and may cooperate to thereby implement functions of the authentication device 20 described above.

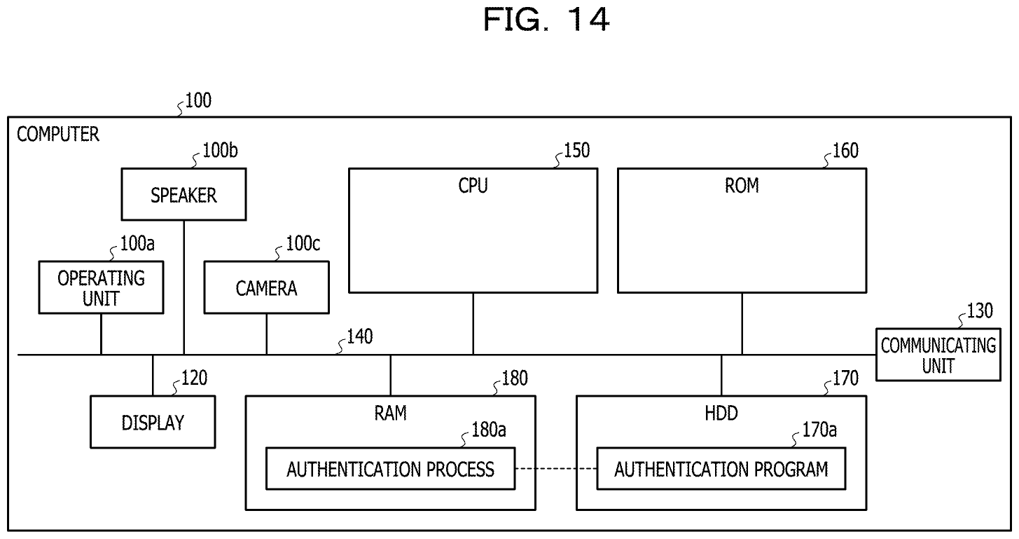

In addition, the various kinds of processing described in the foregoing embodiments may be implemented by executing a program prepared in advance in a computer such as a personal computer, or a workstation. Accordingly, referring to FIG. 14, the following description will be made of an example of a computer that executes an authentication program including a plurality of instructions having functions similar to those of the foregoing embodiments.

FIG. 14 is a diagram illustrating an example of a hardware configuration of a computer that executes an authentication program according to the first and second embodiments. As illustrated in FIG. 14, the computer 100 includes an operating unit 110a, a speaker 110b, a camera 110c, a display 120, and a communicating unit 130. The computer 100 further includes a CPU 150, a ROM 160, an HDD 170, and a RAM 180. These units 110 to 180 are connected to each other via a bus 140.

As illustrated in FIG. 14, the HDD 170 stores an authentication program 170a that exerts functions similar to those of the receiving section 15a, the identifying section 15b, the authentication section 15c, and the output section 15d illustrated in the foregoing first embodiment. In addition, the HDD 170 may store the authentication program 170a that exerts functions similar to those of the receiving section 15a, the identifying section 15b, the authentication section 15c, the output section 15d, the generating section 25a, and the determining section 25b illustrated in the foregoing second embodiment. As with the constituent elements illustrated in FIG. 3 or FIG. 7, the authentication program 170a may be integrated or separated. For example, the HDD 170 may not need to store all of the data illustrated in the foregoing first embodiment, but it suffices to store data used for processing on the HDD 170.

Under such an environment, the CPU 150 reads the authentication program 170a from the HDD 170, and then expands the authentication program 170a in the RAM 180. As a result, as illustrated in FIG. 14, the authentication program 170a functions as an authentication process 180a. The authentication process 180a expands various kinds of data read from the HDD 170 in an area assigned to the authentication process 180a in a storage area of the RAM 180, and performs various kinds of processing using the expanded various kinds of data. For example, the processing illustrated in FIG. 6, the processing illustrated in FIG. 12 and FIG. 13, or the like is included as an example of the processing performed by the authentication process 180a. In the CPU 150, not all of the processing sections illustrated in the foregoing first embodiment need to operate, and it suffices to virtually implement processing sections corresponding to processing to be performed.

Incidentally, the authentication program 170a described above may not need to be stored on the HDD 170 or in the ROM 160 from the beginning. For example, the authentication program 170a is stored on a “portable physical medium” such as a flexible disk, or a so-called FD, a CD-ROM, a DVD disk, a magneto-optical disk, or an IC card inserted into the computer 100. The computer 100 may then obtain the authentication program 170a from these portable physical media, and execute the authentication program 170a. In addition, the authentication program 170a may be stored in advance in another computer, a server device, or the like connected to the computer 100 via a public line, the Internet, a LAN, a wide area network (WAN), or the like, and the computer 100 may obtain the authentication program 170a from the other computer, the server device, or the like and execute the authentication program 170a.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-implemented authentication method comprising:
when receiving first identification information of a first terminal and first feature information from the first terminal, by referring to relational information indicating relation between identification information of each terminal and identification information of each user, identifying one or more pieces of feature information associated with the first identification information; and
performing a first authentication process based on a result of comparison between the identified one or more pieces of feature information and the received first feature information.

2. The authentication method according to claim 1, wherein
the first feature information is biological information.

3. The authentication method according to claim 1, further comprising:
when the first authentication process succeeds, generating first session information of the first authentication process, and
when an authentication continuation request is received from the first terminal, determining whether to allow continuation of an authenticated state of the first terminal in accordance with another result of comparison between session information included in the authentication continuation request and the first session information.

4. The authentication method according to claim 3, wherein
the first session information includes at least one of an IP address of the first terminal and an execution time of the first authentication process.

5. The authentication method according to claim 3, wherein
the determining whether to allow the continuation is performed based on area information indicating an area where the first session information is usable and time information indicating a duration when the first session information is usable.

6. The authentication method according to claim 1, further comprising:
when the first authentication process fails, performing second authentication process based on another result of comparison between other one or more pieces of feature information not related to the first identification information and the first feature information.

7. The authentication method according to claim 1, further comprising:
when the second authentication process succeeds due to matching between the first feature information and second feature information included in the other one or more pieces of feature information, adding the second feature information in association with the first identification information into the relational information.

8. An authentication device comprising:
a memory; and
a processor coupled to the memory and the processor configured to:
when receiving first identification information of a first terminal and first feature information from the first terminal, by referring to relational information indicating relation between identification information of each terminal and identification information of each user, identify one or more pieces of feature information associated with the first identification information, and
perform a first authentication process based on a result of comparison between the identified one or more pieces of feature information and the received first feature information.

9. The authentication device according to claim 8, wherein
the first feature information is biological information.

10. The authentication device according to claim 8, wherein
the processor is further configured to:
when the first authentication process succeeds, generate first session information of the first authentication process, and
when an authentication continuation request is received from the first terminal, perform determination of whether to allow continuation of an authenticated state of the first terminal in accordance with another result of comparison between session information included in the authentication continuation request and the first session information.

11. The authentication device according to claim 10, wherein
the first session information includes at least one of an IP address of the first terminal and an execution time of the first authentication process.

12. The authentication device according to claim 10, wherein
the determination of whether to allow the continuation is performed based on area information indicating an area where the first session information is usable and time information indicating a duration when the first session information is usable.

13. The authentication device according to claim 8, wherein
the processor is further configured to, when the first authentication process fails, perform second authentication process based on another result of comparison between other one or more pieces of feature information not related to the first identification information and the first feature information.

14. The authentication device according to claim 8, wherein
the processor is further configured to, when the second authentication process succeeds due to matching between the first feature information and second feature information included in the other one or more pieces of feature information, add the second feature information in association with the first identification information into the relational information.

15. A non-transitory computer-readable medium storing instructions executable by one or more computers, the instructions comprising:
one or more instructions for, when receiving first identification information of a first terminal and first feature information from the first terminal, by referring to relational information indicating relation between identification information of each terminal and identification information of each user, identifying one or more pieces of feature information associated with the first identification information; and
one or more instructions for performing a first authentication process based on a result of comparison between the identified one or more pieces of feature information and the received first feature information.
